(19) United States
(12) Patent Application Publication
(10) Pub. No.: US 2003/0207736 A1
(43) Pub. Date: Nov. 6, 2003

(54) Infant walker/trainer

(76) Inventor: Gerardo Munguia JR., Las Vegas, NV (US)

Correspondence Address: K. S. Cornaby, Jones, Waldo, Holbrook & McDonough, Suite 1500, 170 South Main Street, Salt Lake City, UT, 84101, US

(21) Appl. No.: 10/137,976

(22) Filed: May 3, 2002

(51) Int. Cl. A61H 3/00; A47D 13/04; A63B 22/00

(52) U.S. Cl. 482/69

(57) ABSTRACT

An infant trainer for assisting an infant in learning to walk having a lateral support bar adapted to be secured around the stomach and chest area of an infant; and having a rigid upwardly extending support member attached to the rear of the lateral support bar; and having a handle at the upper end of the support bar to guide the trainer and to support an infant contained therein; and having support straps to be secured around the infant to hold the infant within the trainer.

### BACKGROUND OF THE INVENTION

This is a device which allows an adult to completely and safely support an infant during the time the infant is learning to walk. The adult is able to support the infant with only one hand leaving the other hand free to maintain balance and control while training the infant to walk. The device is designed to be secured firmly around the infant's waist and chest allowing for free and natural movement of the arms and legs. The adult grasps a handle attached to a semi-rigid stem above and behind the infant giving the adult the ability to totally control the infant's travel, guiding the infant in a safe manner avoiding any hazardous obstacles. This device may also be used by properly trained therapists with small children in certain therapeutic situations.

The baby cruiser is used to support infants that are about to take their first steps. It helps develop coordination, motor skills and confidence while still giving the baby a sense of security.

It helps strengthen the baby's legs while supporting the back to create the freedom of walking without fear. The baby cruiser has been designed with the parent and baby in mind to give precious moments together, which are so important during the formative years of life.

### SUMMARY OF THE INVENTION

This device contains a unique feature in the handle which allows the adult to totally control and guide the infant with one hand. This is accomplished by creating the support stem to rise upwardly and behind the infant in a semi-rigid mode, creating a guidance system that provides total control of the infant.

### BRIEF DESCRIPTION OF THE DRAWINGS

A preferred embodiment of the invention is illustrated in the accompanying drawings:

FIG. 1 is a perspective view disclosing the invention.

FIG. 2 is a front view of the infant walker/trainer.

FIG. 3 is a right side view of the infant walker/trainer.

FIG. 4 is a left side view of the infant walker/trainer.

### DETAILED DESCRIPTION OF THE INVENTION

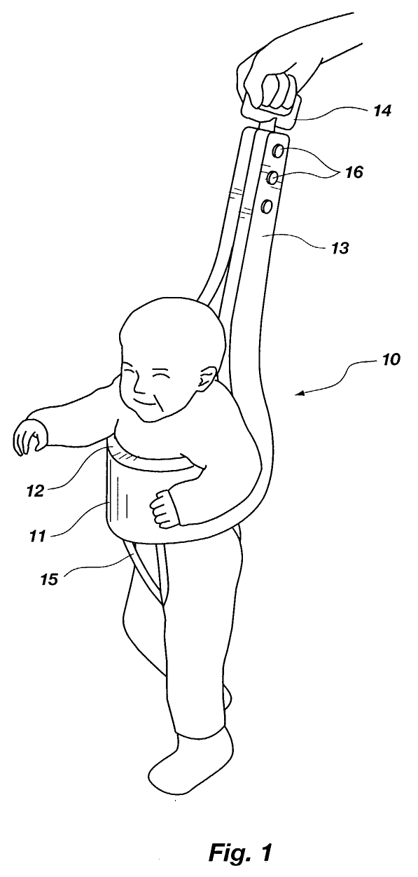

As shown in FIG. 1, an infant trainer 10 of the present invention has a padded semi-rigid support bar 11 in a half-circle wrapping around the front of an infant and extending to the rear of the infant. The bar 11 passes underneath the arms of the infant, so that the infant can rest its arms on the top most side 12 of the bar 1 1.

Bar 11, extends upwardly behind the infant to form a rigid vertical support and guidance member 13 which culminates at the upper end in a handle 14. In this construction, the handle 14 can be used both to support the infant as well as guide the infant as it begins to take steps.

Bar 11 also has a plurality of support straps 15 which extend downwardly from the bar 11 between the infant's legs to secure the bar 11 around the infant and to prevent bar 11 from falling off the infant. In the embodiment shown in FIG. 1, the two ends of bar 11 rising upwardly as support member 13 are secured together at the upper end thereof with rivets or bolts 16, which may also be used to secure handle 14 to member 13.

Material which can be employed to pad support bar 11 include foamed materials covered in a durable fabric to resist scuffing and wear, but also to provide comfort to the infant.

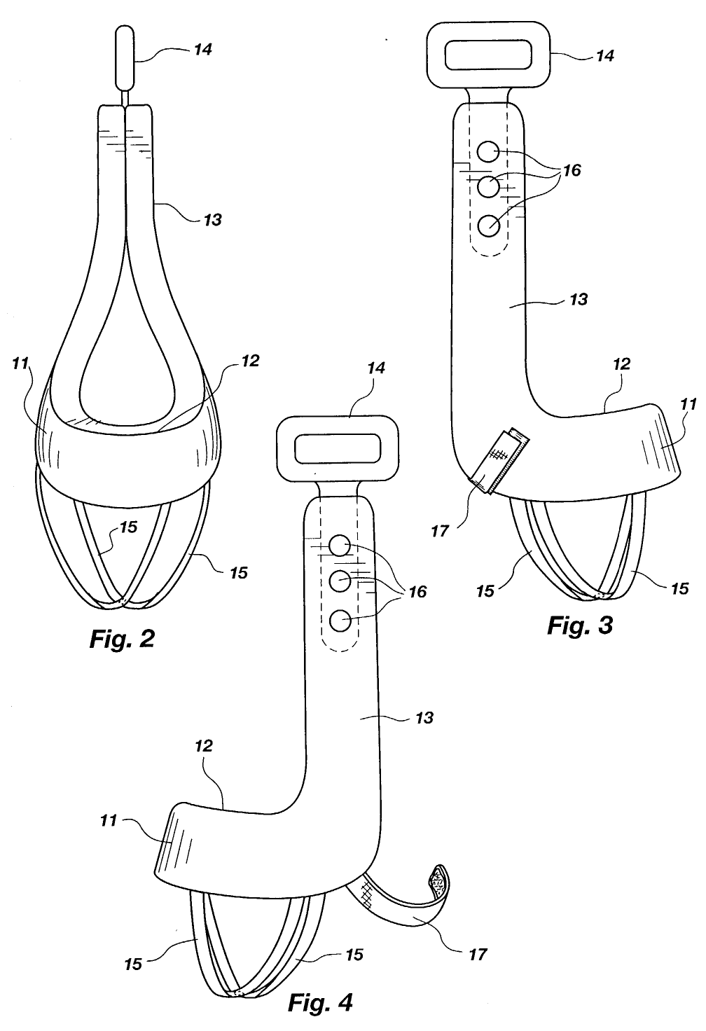

As shown in FIGS. 2, 3 and 4, the infant trainer 10 can also be provided with a securing belt 17, which attaches at the lower end of the upwardly extending support and guidance member 13, and is adapted to be secured around the back of the infant to hold the infant securely within the bar 11 of the trainer 10. This feature prevents the infant from rearing backwardly and falling out of the trainer 10.

Strap 15 may be constructed of suitable fabric with some resilience to provide comfort to the infant while ensuring that the infant is secure within support bar 11.

While this invention has been described and illustrated herein with respect to preferred embodiments, it is understood that alternative embodiments and substantial equivalents are included within the scope of the invention as defined by the appended claims.

I claim:

1. An infant walking trainer for training infants to walk, comprising:
a lateral support means adapted to be secured around the waist and chest area of an infant;
a vertically extending support means attached to said lateral support means, said vertically extending support means adapted to extend behind the infant; and
handle means secured to the upper end of said vertically extending support means.

2. An infant walking trainer as set forth in claim 1, wherein said lateral support means is a half-circular padded support bar for extending around the waist and chest of the infant.

3. An infant walking trainer as set forth in claim 1, wherein said vertically extending support means is a vertically extending rigid member extending upwardly from the rearward part of said lateral support means.

4. An infant walking trainer as set forth in claim 1, wherein said lateral support means has a plurality of straps extending downwardly adapted to be secured between the infant's legs to prevent the infant from falling out of said lateral support means.

5. An infant walking trainer as set forth in claim 1, including belt means attached to the vertical support means, adapted to hold the infant within the trainer.
